(19) United States
(12) Patent Application Publication
(10) Pub. No.: US 2021/0104777 A1
(43) Pub. Date: Apr. 8, 2021

(54) SOLID ELECTROLYTE FOR ELECTROCHEMICAL DEVICES

(71) Applicant: I-TEN, Dardilly (FR)

(72) Inventors: Fabien GABEN, Dardilly (FR); Anne-Charlotte FAURE, Villeurbanne (FR)

(21) Appl. No.: 17/049,983

(22) PCT Filed: May 6, 2019
(86) PCT No.: PCT/FR2019/051032

§ 371 Date: Oct. 23, 2020

(30) Foreign Application Priority Data
May 7, 2018 (FR) 1853923

(51) Int. Cl. H01M 10/0565; H01M 10/0585; H01G 11/84; H01G 11/56

(52) U.S. Cl. CPC H01M 10/0565; H01M 10/0585; H01M 10/0525; H01G 11/56; H01G 11/84

(57) ABSTRACT

Method for manufacturing a solid electrolyte for lithium-ion battery or supercapacitor, deposited on an electrode, comprising the steps of:
a. providing a conductive substrate, covered beforehand with a layer of material that can be used as an electrode (“electrode layer”),
b. deposition on said electrode layer of an electrolyte layer, preferably by electrophoresis or by dip-coating, from a suspension of core-shell particles comprising, as a core, a particle of a material that can be used as an electrolyte or electric insulator, on which a shell comprising PEO is grafted;
c. drying the electrolyte layer thus obtained, preferably in an airflow;
d. optionally, densifying said electrolyte layer by mechanical compression and/or heat treatment.

### TECHNICAL FIELD OF THE INVENTION

The invention relates to the field of electrochemistry, and more particularly all-solid-stated lithium-ion batteries. It relates more precisely to solid electrolytes and more particularly thin layer electrolytes that can be used in these electrochemical systems.

The invention also relates to a method for preparing such an electrolyte, preferably with thin layers, that implements nanoparticles of solid electrolyte materials, preferably lithium phosphate on which molecules of PEO have been grafted, and the electrolytes thus obtained. The invention also relates to a method for manufacturing an electrochemical device comprising at least one of these electrolytes, and the devices thus obtained.

### STATE OF THE ART

A lithium-ion battery is an electrochemical component that makes it possible to store electrical energy. Generally, it is comprised of one or more elementary cells, and each cell comprises two electrodes with opposite polarity and an electrolyte. Various types of electrodes can be used in secondary lithium-ion batteries. A cell can comprise two electrodes separated by a polymeric porous membrane (also called “separator”) impregnated with a liquid electrolyte containing a lithium salt.

For example, patent application JP 2002-042792 discloses a process for depositing by electrophoresis a solid electrolyte on an electrode of a battery. The electrolytes described are substantially polymeric membranes such as polyethylene oxide, polyacrylonitrile, poly(vinylidene fluoride) of which the pores are impregnated by a lithium salt such as LiPF₆. According to the teachings of this document, the size of the particles deposited by electrophoresis must preferably be less than 1 μm, and the thickness of the layer formed is preferably less than 10 μm. In such a system, the liquid electrolyte migrates into the pores contained in the membrane and to the electrodes, and thus provides ionic conduction between the electrodes.

With the purpose of creating high power batteries and reducing the resistance to transport of the lithium ions between the two electrodes, it was sought to increase the porosity of the polymeric membrane. However, increasing the porosity of the polymeric membranes facilitates the precipitation of metal lithium dendrites in the pores of the polymeric membrane during the charging and discharging cycles of the battery. These dendrites are the origin of internal short-circuits within the cell that can induce a risk of thermal runaway of the battery.

It is known that these polymeric membranes impregnated with a liquid electrolyte have a lower ionic conductivity than the liquid electrolyte used. It can be sought to offset this effect by decreasing the thickness of the membranes. However, these polymeric membranes are mechanically fragile and their electrical insulation properties can be altered under the effect of strong electrical fields such as is the case in batteries charged with electrolyte films of a very thin thickness, or under the effect of mechanical and especially vibratory stresses. These polymeric membranes tend to break during charging and discharging cycles, causing the detaching of particles of anode and cathode; this can cause a short-circuit between the two positive and negative electrodes, which can lead to dielectric breakdown. This risk is furthermore accentuated in batteries that use porous electrodes.

To improve mechanical resistance, Ohara has proposed, in particular in documents EP 1 049 188 A1 and EP 1 424 743 B1, using electrolytes comprised of a polymeric membrane containing lithium ion-conducting vitroceramic particles.

Moreover, it is known from Maunel et al. (Polymer 47 (2006) p. 5952-5964) that adding ceramic charges in the polymer matrix makes it possible to improve the morphological and electrochemical properties of the polymeric electrolytes; these ceramic charges can be active (such as Li₂N, LiAl₂O₃), in which case they participate in the process of transporting lithium ions, or be passive (such as Al₂O₃, SiO₂, MgO), in which case they do not participate in the process of transporting lithium ions. The size of the particles and the characteristics of the ceramic charges influence the electrochemical properties of the electrolytes, see Zhang et al., “Flexible and ion-conducting membrane electrolytes for solid-state lithium batteries: Dispersions of garnet nanoparticles in insulating POE”, NanoEnergy, 28 (2016) p. 447-454. However, these membranes are relatively fragile and easily break under the effect of mechanical stresses induced during the assembly of batteries.

One of the most studied electrolytic systems is that comprised of poly(ethylene oxide) (abbreviated hereinafter as PEO), in which a lithium salt is dissolved. PEO alone is not a very good conductor of lithium ions, but the integration of liquid electrolytes into the polymer matrix favors the formation of an amorphous phase of PEO, which conducts the lithium ions better.

It is known that adding ionic liquids in a PEO matrix impregnated with lithium salts has disadvantages. The first disadvantage is that it degrades the transport number of the electrolyte: only solid electrolytes without lithium salts or ionic liquids (such as lithium phosphates) have a transport number equal to 1. The second disadvantage is that the chemical stability of PEO at high potential is not as good when the PEO matrix is impregnated with lithium salts et/or ionic liquids than when it contains nanoparticles of solid electrolyte (see the publication of Zhang mentioned hereinabove). In these electrolytes, the conduction is substantially provided by the nanoparticles; the amorphous phases of the PEO favor the transfer of lithium ions to the interfaces, on the one hand between the particles and on the other hand between the particles and the electrodes.

The deposition of PEO charged with nanoparticles of solid electrolyte, whether or not the latter is impregnated with a liquid electrolyte, is done typically by coating. The adding of nanoparticles of solid electrolyte increases however the viscosity of the suspension of the electrolyte used for the coating. A viscosity that is too high no longer makes it possible to create a thin layer by conventional coating techniques. Moreover, these electrolytes generally remain thick, which contributes to increasing their electrical resistance. And finally, the nanoparticles in these electrolytes risk being in the form of agglomerates, which limits their contact surfaces with the PEO and therefore is detrimental to their effectiveness and prevents good quality thin films from being obtained. It is indeed observed that all the electrolytes described in literature have a content in particles less than 30% by volume.

The present invention aims to overcome at least a portion of the disadvantages of the prior art.

The problem that this invention seeks to resolve is to propose electrolytes that are safe and that can be used in a thin layer, that have a high ionic conductivity and a transport number close to 1, a stable mechanical structure and a substantial service life.

Another problem that this invention seeks to resolve is to provide a method of manufacturing such an electrolyte that is simple, safe, fast, easy to implement, easy to industrialize and inexpensive.

Another purpose of the invention is to propose electrodes for batteries that can operate reliably and without the risk of fire.

Another objective of the invention is to provide a battery with a rigid structure that has a high power density able to mechanically resist impacts and vibrations.

Another objective of the invention is to provide a method for manufacturing an electronic, electric or electrotechnical device such as a battery, a capacitor, a supercapacitor, a photovoltaic cell comprising an electrolyte according to the invention.

Another objective of the invention is to propose devices such as batteries, lithium ion battery cells, capacitors, supercapacitors, photovoltaic cells that have increased reliability, have a longer service life and that can be encapsulated by coatings deposited by the atomic layer deposition technique (ALD), at a high temperature and under reduced pressure.

### PURPOSES OF THE INVENTION

According to the invention the problem is resolved by using at least one electrolyte that has a homogeneous composite structure comprising a volume ratio of solid electrolyte/PEO greater than 35%, preferably greater than 50%, preferably greater than 60%, and even more preferably greater than 70% by volume. The high content in solid electrolyte combined with its homogenous dispersion provides this structure with good mechanical resistance. A second object of the invention is a method for manufacturing an electrolyte, preferably solid, preferably with a thin layer, for lithium-ion battery or supercapacitor, deposited on an electrode, comprising the steps of:
a. providing a conductive substrate, covered beforehand with a layer of material that can be used as an electrode (“electrode layer”),
b. deposition on said electrode layer of an electrolyte layer, preferably by electrophoresis or by dip-coating, from a suspension of core-shell particles comprising, as a core, a particle of a material that can be used as an electrolyte and/or electronic insulator, on which a shell comprising PEO is grafted;
c. Drying the electrolyte layer that is thus obtained, preferably in an airflow;
d. optionally, densifying said electrolyte layer by mechanical compression and/or heat treatment.

Advantageously, the electrolyte according to the invention can be obtained from the deposition on said electrode layer of an electrolyte layer, preferably by electrophoresis or by dip-coating, from a suspension comprising core-shell particles comprising, as a core, a particle of a material that can be used as an electrolyte, on which a shell comprising PEO is grafted, and/or comprising core-shell particles comprising, as a core, a particle of a material that can be used as an electronic insulator, on which a shell comprising PEO is grafted.

Preferably, the average size D₅₀ of primary core particles is less than 100 nm, preferably less than 50 nm and even more preferably less than or equal to 30 nm. Advantageously, the primary core particles are obtained by hydrothermal or solvothermal synthesis.

Advantageously, the thickness of the shell of the particles is comprised between 1 nm and 100 nm.

Advantageously, the electrolyte layer obtained in step c) or d) has a thickness less than 10 μm, preferably about 6 μm and more preferably about 3 μm.

Advantageously, the PEO has a weight average molar weight less than 7,000 g/mol, preferably about 5,000 g/mol.

Advantageously, the dry extract of the suspension of core-shell particles used in step b) is less than 30% by weight.

The method according to the invention can be used for the manufacture of electrolytes, preferably solid, preferably with a thin layer, in devices selected from the group formed by: batteries, capacitors, supercapacitors, capacitors, resistors, inductances, transistors.

Another object of the invention is an electrolyte that can be obtained by the method according to the invention, preferably a solid electrolyte, preferably a thin layer electrolyte.

Advantageously, the electrolyte according to the invention, preferably with a thin layer, comprising a solid electrolyte and PEO, has a volume ratio of solid electrolyte/PEO greater than 35%, preferably greater than 50%, preferably greater than 60%, and even more preferably greater than 70%.

Advantageously, the electrolyte according to the invention, preferable with a thin layer, has a porosity less than 20%, preferably less than 15%, more preferably less than 10%.

Another object of the invention is an electrochemical device comprising at least one electrolyte, preferably a solid electrolyte, preferably an electrolyte with a thin layer, according to the invention, preferably a lithium-ion battery or a supercapacitor.

Another object of the invention is a method for manufacturing a lithium-ion battery implementing the method according to the invention, and comprising the steps of:
i. Providing at least two conductive substrates that be used as current collectors of the battery, covered beforehand with a layer of a material that can be used as an anode and respectively as a cathode (“anode layer” 12 respectively “cathode layer” 22), and being covered over at least one portion of at least one of their faces with a cathode layer, respectively anode layer,
ii. Providing of a colloidal suspension comprising core-shell nanoparticles comprising as a core, a particle of a material that can be used as an electrolyte and/or electronic insulator, on which a shell comprising PEO is grafted,
iii. Deposition of an electrolyte layer, preferably by electrophoresis or by dip-coating, from a suspension comprising core-shell particles obtained in step ii), on a cathode layer, and/or anode layer obtained in step i), to obtain and first and/or a second intermediate structure,
iv. Drying of the layer thus obtained in step iii), preferably in an air flow,
v. Creating a stack from said first and/or second intermediate structure to obtain a stack of the “substrate/anode/electrolyte/cathode/substrate” type:
   either by depositing an anode layer 12 on said first intermediate structure,
   or by depositing a cathode layer 22 on said second intermediate structure,
   or by superposing said first intermediate structure and said second intermediate structure in such a way that the two electrolyte layers are placed one on the other,
vi. Densification of the stack obtained in the preceding step by mechanical compression and/or heat treatment of the stack leading to the obtaining of a cell, preferably a battery.

When the battery obtained in step vi) comprises at least one porous cathode layer 22 and/or at last one porous anode layer 12, preferably mesoporous, the method of manufacturing a lithium-ion battery according to the invention, comprises a step of impregnating the battery obtained in step vi) by a phase carrying lithium ions leading to the obtaining of an impregnated battery.

The order of steps i) and ii) is not important.

Advantageously, said material that can be used as an electronic insulator is preferably chosen from Al₂O₃, SiO₂, ZrO₂.

Advantageously, the cathode is a dense electrode,
or a dense electrode coated by ALD or chemically in a solution (CSD) with an electronically-insulating layer, preferably an electronically insulating and ionic conducting layer,
or a porous electrode,
or a porous electrode coated by ALD or chemically in a solution (CSD) with an electronically-insulating layer, preferably an electronically insulating and ionic conducting layer,
or, preferably, a mesoporous electrode,
or a mesoporous electrode coated by ALD or chemically in a solution (CSD) with an electronically-insulating layer, preferably an electronically insulating and ionic conducting layer,
   and/or wherein the anode is a dense electrode
   or a dense electrode coated by ALD or chemically in a solution (CSD) with an electronically-insulating layer, preferably an electronically insulating and ionic conducting layer,
   or a porous electrode,
   or a porous electrode coated by ALD or chemically in a solution (CSD) with an electronically-insulating layer, preferably an electronically insulating and ionic conducting layer,
   or, preferably, a mesoporous electrode,
   or a mesoporous electrode coated by ALD or chemically in a solution (CSD) with an electronically-insulating layer, preferably an electronically insulating and ionic conducting layer. These layers can be deposited by chemical solution, known under the acronym CSD (Chemical Solution Deposition).

Advantageously, after step vi) or after the impregnation step:
is deposited successively, alternating, on the battery:
   at least one first layer of parylene and/or polymide on said battery,
   at least one second layer composed of an electrically-insulating material by atomic layer deposition (ALD) on said first layer of parylene and or polyimide,
   and on the alternating succession of at least one first and of at least one second layer is deposited a layer making it possible to protect the battery from mechanical damage of the battery, preferably made of silicone, epoxy resin, or parylene or polyimide, thus forming, an encapsulation system of the battery,
the battery thus encapsulated is cut along two cutting planes to expose on each one of the cutting plans anode and cathode connections of the battery, in such a way that the encapsulation system covers four of the six faces of said battery, preferably continuously,
is deposited successively, on and around, these anode and cathode connections:
   a first electrically-conductive layer, optional, preferably deposited by ALD,
   a second layer with an epoxy resin base charged with silver, deposited on the first electronically-conductive layer, and
   a third layer with a nickel base, deposited on the second layer, and
   a fourth layer with a tin or copper base, deposited on the third layer.
Advantageously and alternatively, after step vi) or after the impregnation step: is deposited successively, alternating, on the battery, an encapsulation system formed by a succession of layers, namely a sequence, preferably z sequences, comprising:
   a first covering layer, preferably chosen from parylene, parylene of the F type, polyimide, epoxy resins, silicone, polyamide and/or a mixture of the latter, deposited on the assembled stack,
   a second covering layer comprised of an electrically-insulating material, deposited by atomic layer deposition on said first covering layer,
   this sequence can be repeated z times with z 1,
a last covering layer is deposited in this succession of layers of a material chosen from epoxy resin, polyethylene napthalate (PEN), polyimide, polyamide, polyurethane, silicone, sol-gel silica or organic silica,
the battery thus encapsulated is cut along two cutting planes to expose on each one of the cutting plans anode and cathode connections of the battery, in such a way that the encapsulation system covers four of the six faces of said battery, preferably continuously,
optionally, the encapsulated battery thus cut is impregnated with a phase carrying lithium ions in particular when this battery comprises a porous electrode,
is deposited successively, on and around, these anode and cathode connections:
   a first layer of a material charged with graphite, preferably epoxy resin charged with graphite,
   a second layer comprising metal copper obtained from an ink charged with nanoparticles of copper deposited on the first layer,
the layers obtained are thermally treated, preferably by infrared flash lamp in such a way as to obtain a covering of the cathode and anode connections by a layer of metal copper,
possibly, is deposited successively, on and around, this layer of metal copper:
   a first layer of a tin-zinc alloy deposited, preferably by dipping in a molten tin-zinc bath, so as to ensure the tightness of the battery at least cost, and
   a second layer with a pure tin base deposited by electrodeposition or a second layer comprising an alloy with a silver, palladium and copper base deposited on this first layer of a tin-zinc alloy.

Preferably, the anode and cathode connections are on the opposite sides of the stack. Another object of the invention is a lithium-ion battery able to be obtained by this method. Another object of the invention is a lithium-ion battery comprising an electrolyte according to the invention.

### BRIEF DESCRIPTION OF THE FIGURES

FIG. 1 diagrammatically shows a front view with the pulling-out of a battery comprising an electrolyte according to the invention and showing the structure of the battery comprising, for the purposes of illustration, an assembly of elementary cells covered by a system of encapsulation and terminations.

### LIST OF MARKS USED IN THE FIGURES

TABLE 1

| | | | |
|---|---|---|---|
| 1 | Battery | 22 | Layer of a cathode active |
| | | | material |
| 11 | Layer of a substrate used | 23 | Layer of an electrolyte material |
| | as a current collector | | according to the invention |
| 12 | Layer of an anode active | 30 | Encapsulation system |
| | material | | |
| 13 | Layer of an electrolyte | 40 | Termination |
| | material according | | |
| | to the invention | | |
| 21 | Layer of a substrate used | 50 | Anode and/or cathode |
| | as a current collector | | connections |

### DESCRIPTION OF THE INVENTION

In the context of this document, the particle size is defined by its largest dimension. “Nanoparticle” refers to any particle or object of a nanometric size D₅₀ that has at least one of its dimensions less than or equal to 100 nm.

In the framework of this document, a material or an electronically-insulating layer, preferably an electronically-insulating and ionic conducting layer is a material or a layer of which the electrical resistance (resistance to the passage of electrons) is greater than 10⁵ Ω·cm. “Thin layer” means any film with a thickness less than 10 μm.

“Mesoporous materials” refers to any solid that has within its structure pores referred to as “mesopores” that have a size that is intermediate between that of micropores (width less than 2 nm) and that of macropores (width greater than 50 nm), namely a size comprised between 2 nm and 50 nm. This terminology corresponds to that adopted by IUPAC (International Union for Pure and Applied Chemistry), which is a reference for those skilled in the art. Therefore the term “nanopore” is not used here, although mesopores such as defined hereinabove have nanometric dimensions in terms of the definition of nanoparticles, knowing that pores of a size less than that of mesopores are called “micropores” by those skilled in the art.

A presentation of the concepts of porosity (and of the terminology that has just been disclosed hereinabove) is given in the article “Texture des matériaux pulvérulents ou poreux” by F. Rouquerol et al. published in the collection “Techniques de l'lngénieur”, traité Analyse et Caractérisation, fascicule P 1050; this article also describes the techniques for characterizing porosity, in particular the BET (Brunauer, Emmet and Teller) method.

In terms of this invention, “mesoporous layer” refers to a layer that has mesopores.

To implement the method according to the invention nanoparticles of electrolyte or electronic insulator are provided, preferably in the form of a suspension in a liquid phase. Nanoparticles of electrolyte can be obtained by nanogrinding/dispersion of a solid electrolyte powder (or electronic insulator) or by hydrothermal synthesis or by solvothermal synthesis or by precipitation. Preferably, a method will be chosen that makes it possible to obtain primary nanoparticles of a very homogenous size (monodispersed). The solvothermal path is preferred, for example hydrothermal, which leads to nanoparticles that have a very homogenous size, good crystallinity and purity, although nanogrinding tends to deteriorate the solid nanoparticles. The synthesis of nanoparticles by precipitation makes it possible to obtain primary nanoparticles of a very homogenous size, with good crystallinity and purity.

1. Functionalization of Nanoparticles of Material that can be Used as an Electrolyte or Electronic Insulator by PEO

Nanoparticles of electrolyte or electronic insulator can then be functionalized with organic molecules in a liquid phase, according to methods known to these skilled in the art. Functionalization consists in grafting on the surface of the nanoparticles a molecule that has a structure of the Q-Z type wherein Q is a function that provides the attaching of the molecule on the surface, and Z is a PEO group.

As a Q group, a complexing function of the surface cations of the nanoparticles can be used such as the phosphate or phosphonate function.

Preferably, the nanoparticles of electrolyte or electronic insulator are functionalized by a PEO derivative of the type

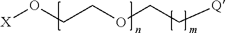

where X represents an alkyl chain or a hydrogen atom,
n is comprised between 40 and 10,000 (preferably between 50 and 200),
m is comprised between 0 and 10, and
Q′ is an embodiment of Q and represents a group selected from the group formed by:

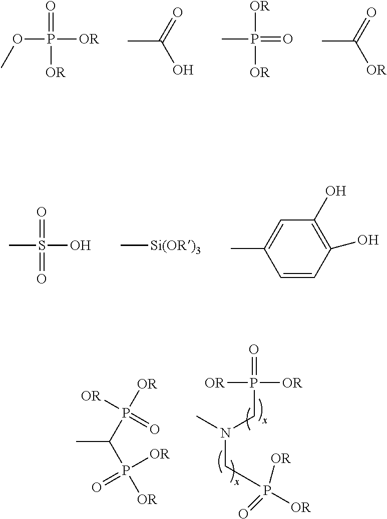

and where R represents an alkyl chain or a hydrogen atom, R′ represents a methyl group or an ethyl group, x is comprised between 1 and 5, and x′ is comprised between 1 and 5.

More preferably, the nanoparticles of electrolyte or electronic insulator are functionalized by methoxy-PEO-phosphonate

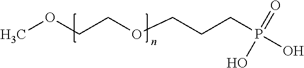

where n is comprised between 40 and 10,000 and preferably between 50 and 200.

According to an advantageous embodiment, a solution of Q-Z (or Q′-Z, where applicable) is added to a colloidal suspension of nanoparticles of electrolyte or electronic insulator in such a way as to obtain a molar ratio between Q (that here comprises Q′) and all of the cations present in the nanoparticles of electrolyte or electronic insulator (abbreviated here “NP-E”) comprised between 1 and 0.01, preferably between 0.1 and 0.02. Beyond a molar ratio Q/NP-E of 1, the functionalization of the nanoparticles of electrolyte or electronic insulator by the molecule Q-Z risks inducing a steric hindrance such that the particles of electrolyte cannot be fully functionalized; this also depends on the particle size. For a molar ratio Q/NP-E less than 0.01, the molecule Q-Z risks not being of sufficient quantity to provide a sufficient conductivity of lithium ions; this also depends on the particle size. Using a higher quantity of Q-Z during functionalization would result in unnecessary consumption of Q-Z.

Advantageously, the material that can be used as an electronic insulator is preferably chosen from Al₂O₃, SiO₂, ZrO₂, and/or a material selected in the group formed by the electrolyte materials hereinafter.

Advantageously, the nanoparticles of electrolyte are chosen from:
garnets of formula Li_{d} A¹ₓ A2_{y}(TO₄)_{z} where
   A¹ represents a cation of oxidation state +II, preferably Ca, Mg, Sr, Ba, Fe, Mn, Zn, Y, Gd; and where
   A² represents a cation of oxidation state +III, preferably Al, Fe, Cr, Ga, Ti, La; and where
   (TO₄) represents an anion wherein T is an atom of oxidation state +IV, located at the center of a tetrahedron formed by the oxygen atoms, and wherein TO₄ advantageously represents the silicate or zirconate anion, knowing that all or a portion of the elements T of an oxidation state +IV can be replaced by atoms of an oxidation state +III or +V, such as Al, Fe, As, V, Nb, In, Ta;
   knowing that: d is comprised between 2 and 10, preferably between 3 and 9, and even more preferably between 4 and 8; x is comprised between 2.6 and 3.4 (preferably between 2.8 and 3.2); y is comprised between 1.7 and 2.3 (preferably between 1.9 and 2.1) and z is comprised between 2.9 and 3.1;
garnets, preferably chosen from: oxides of the type LLZO, Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓM₂O₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds;
lithium phosphates, preferably chosen from: lithium phosphates of the NaSICON type, Li₃PO₄; LiPO₃; Li₃Al_{0.4}Sc_{1.6}(PO₄)₃ called “LASP”; Li_{1.2}Zr_{1.9}Ca_{0.1}(PO₄)₃; LiZr₂(PO₄)₃; Li₁₊₃ₓZr₂(P₁₋ₓSiₓO₄)₃ with 1.8<x<2.3; Li₁₊₆ₓZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0≤x≤1 called “LATP”; or Li₁₊ₓAlₓGe₂₋ₓ(PO₄)₃ with 0≤x≤1 called “LAGP”; or Li_{1+x+z}Mₓ(Ge_{1-y}Ti_{y})₂₋ₓSi_{z}P_{3-z}O₁₂ with 0≤x≤0.8 and 0≤y≤1.0 and 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM³ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these compounds;
lithium borates, preferably chosen from: Li₃(Sc₂₋ₓMₓ)(BO₃)₃ with M=Al or Y and 0≤x≤1; Li₁₊ₓMₓ(Sc)₂₋ₓ(BO₃)₃ with M=Al, Y, Ga or a mixture of the three compounds and 0≤x≤0.8; Li₁₊ₓMₓ(Ga_{1-y}Sc_{y})₂₋ₓ(BO₃)₃ with 0≤x≤0.8, 0≤y≤1 and M=Al or Y; Li₁₊ₓMₓ(Ga)₂₋ₓ(BO₃)₃ with M=Al, Y or a mixture of the two compounds and 0≤x≤0.8; Li₃BO₃, Li₃BO₃—Li₂SO₄, Li₃BO₃—Li₂SiO₄, Li₃BO₃—Li₂SiO₄—Li₂SO₄;
oxinitrides, preferably chosen from Li₃PO₄₋ₓN_{2x/3}, Li₄SiO₄₋ₓN_{2x/3}, Li₄GeO₄₋ₓN_{2x/3} with 0<X<4 or Li₃BO₃₋ₓN_{2x/3} with 0<x<3;
lithium compounds based on lithium oxinitride and phosphorus, called “LiPON”, in the form LiₓPO_{y}N_{z} with x˜2.8 and 2y+3z˜7.8 and 0.16≤z≤0.4, and in particular Li_{2.9}PO_{3.3}N_{0.46}, but also the compounds Li_{w}POₓN_{y}S_{z} with 2x+3y+2z=5=w or the compounds Li_{w}POₓN_{y}S_{z} with 3.2≤x≤3.8, 0.13≤y≤0.4, 0≤z≤0.2, 2.9≤w≤3.3 or the compounds in the form of LiₜPₓAl_{y}OᵤNᵥS_{w} with 5x+3y=5, 2u+3v+2w=5+t, 2.9≤t≤3.3, 0.84≤x≤0.94, 0.094≤y≤0.26, 3.2≤u≤3.8, 0.13≤v≤0.46, 0≤w≤0.2;
materials based on lithium phosphorus or boron oxinitrides, respectively called “LiPON” and “LIBON”, also able to contain silicon, sulfur, zirconium, aluminum, or a combination of aluminum, boron, sulfur and/or silicon, and boron for the materials based on lithium phosphorus oxinitrides;
lithium compounds based on lithium, phosphorus and silicon oxinitride called “LiSiPON”, and particularly Li_{1.9}Si_{0.28}P_{1.0}O_{1.1}N_{1.0};
lithium oxinitrides of the LiBON, LiBSO, LiSiPON, LiSON, thio-LiSiCON, LiPONB types (where B, P and S represent boron, phosphorus and sulfur respectively);
lithium oxinitrides of the LiBSO type such as (1−x)LiBO₂-xLi₂SO₄ with 0.4≤x≤0.8;
lithium oxides, preferably chosen from Li₇La₃Zr₂O₁₂ or Li₅₊ₓLa₃(Zrₓ,A₂₋ₓ)O₁₂ with A=Sc, Y, Al, Ga and 1.4≤x≤2 or Li_{0.35}La_{0.55}TiO₃ or Li₃ₓLa_{2/3-x}TiO₃ with 0≤x≤0.16 (LLTO);
silicates, preferably chosen from Li₂Si₂O₅, Li₂SiO₃, Li₂Si₂O₆, LiAlSiO₄, Li₄SiO₄, LiAlSi₂O₆;
solid electrolytes of the anti-perovskite type chosen from: Li₃OA with A a halide or a mixture of halides, preferably at least one of the elements chosen from F, Cl, Br, I or a mixture of two or three or four of these elements; Li₍₃₋ₓ₎M_{x/2}OA with 0<x≤3, M a divalent metal, preferably at least one of the elements Mg, Ca, Ba, Sr or a mixture of two or three or four of these elements, A a halide or a mixture of halides, preferably at least one of the elements F, Cl, Br, I or a mixture of two or three or four of these elements; Li₍₃₋ₓ₎M³_{x/3}OA with 0≤x≤3, M³ a trivalent metal, A a halide or a mixture of halides, preferably at least one of the elements F, Cl, Br, I or a mixture of two or three or four of these elements; or LiCOX_{z}Y_{(1-z)}, with X and Y halides such as mentioned hereinabove in relation with A, and 0≤z≤1,
the compounds La_{0.51}Li_{0.34}Ti_{2.94}, Li_{3.4}V_{0.4}Ge_{0.6}O₄, Li₂O—Nb₂O₅;
formulations based on Li₂CO₃, B₂O₃, Li₂O, Al(PO₃)₃LiF, Li₃N, Li₁₄Zn(GeO₄)₄, Li_{3.6}Ge_{0.6}V_{0.4}O₄, LiTi₂(PO₄)₃, Li_{1.3}Al_{0.3}Ti_{1.7}(PO₄)₃, Li₁₊ₓAlₓM₂₋ₓ(PO₄)₃ (where M=Ge, Ti, and/or Hf, and where 0<x<1), Li_{1+x+y}AlₓTi₂₋ₓSi_{y}P_{3-y}O₁₂ (where 0≤x≤1 and 0≤y≤1).

Surprisingly electrolyte layers obtained from nanoparticles of electrolyte functionalized by PEO of which the nanoparticles of electrolyte are chosen from:
garnets of formula Li_{d} A¹ₓ A²_{y}(TO₄)_{z} where
   A¹ represents a cation of oxidation state +II, preferably Ca, Mg, Sr, Ba, Fe, Mn, Zn, Y, Gd; and where
   A² represents a cation of oxidation state +III, preferably Al, Fe, Cr, Ga, Ti, La; and where
   (TO₄) represents an anion wherein T is an atom of oxidation state +IV, located at the center of a tetrahedron formed by the oxygen atoms, and wherein TO₄ advantageously represents the silicate or zirconate anion, knowing that all or a portion of the elements T of an oxidation state +IV can be replaced by atoms of an oxidation state +III or +V, such as Al, Fe, As, V, Nb, In, Ta;
   knowing that: d is comprised between 2 and 10, preferably between 3 and 9, and even more preferably between 4 and 8; x is comprised between 2.6 and 3.4 (preferably between 2.8 and 3.2); y is comprised between 1.7 and 2.3 (preferably between 1.9 and 2.1) and z is comprised between 2.9 and 3.1;
garnets, preferably chosen from: oxides of the type LLZO, Li₇La₃Zr₂O₁₂; Li₆La₂BaTa₂O₁₂; Li_{5.5}La₃Nb_{1.75}In_{0.25}O₁₂; Li₅La₃M₂O₁₂ with M=Nb or Ta or a mixture of the two compounds; Li₇₋ₓBaₓLa₃₋ₓM₂O₁₂ with 0≤x≤1 and M=Nb or Ta or a mixture of the two compounds; Li₇₋ₓLa₃Zr₂₋ₓMₓO₁₂ with 0≤x≤2 and M=Al, Ga or Ta or a mixture of two or three of these compounds; and
lithium phosphates, preferably chosen from: lithium phosphates of the NaSICON type, Li₃PO₄; LiPO₃; Li₃Al_{0.4}Sc_{1.6}(PO₄)₃ called “LASP”; (PO₄)₃; LiZr₂(PO₄)₃; Li₁₊₃xZr₂(P₁₋ₓSiₓO₄)₃ with 1.8<x<2.3; Li₁₊₆xZr₂(P₁₋ₓBₓO₄)₃ with 0≤x≤0.25; Li₃(Sc₂₋ₓMₓ)(PO₄)₃ with M=Al or Y and 0≤x≤1; Li₁₊ₓMₓ(Sc)₂₋ₓ(PO₄)₃ with M=Al, Y, Ga or a mixture of the three compounds and 0≤x≤0.8; Li₁₊ₓMₓ(Ga_{1-y}Sc_{y})₂₋ₓ(PO₄)₃ with 0≤x≤0.8; 0≤y≤1 and M=Al or Y or a mixture of the two compounds; Li₁₊ₓMₓ(Ga)₂₋ₓ(PO₄)₃ with M=Al, Y or a mixture of the two compounds and 0≤x≤0.8; Li₁₊ₓAlₓTi₂₋ₓ(PO₄)₃ with 0x≤1 called “LATP”; or Li₁₊ₓAlₓGe₂₋ₓ(PO₄)₃ with 0≤x≤1 called “LAGP”; or Li_{1+x+z}Mₓ(Ge_{1-y}Ti_{y})₂₋ₓSi_{z}P_{3-z}O₁₂ with 0≤x≤0.8 and 0≤y≤1.0 & 0≤z≤0.6 and M=Al, Ga or Y or a mixture of two or three of these compounds; Li_{3+y}(Sc₂₋ₓMₓ)Q_{y}P_{3-y}O₁₂, with M=Al and/or Y and Q=Si and/or Se, 0≤x≤0.8 and 0≤y≤1; or Li_{1+x+y}MₓSc₂₋ₓQ_{y}P_{3-y}O₁₂, with M=Al, Y, Ga or a mixture of the three compounds and Q=Si and/or Se, 0≤x≤0.8 and 0≤y≤1; or Li_{1+x+y+z}Mₓ(Ga_{1-y}Sc_{y})₂₋ₓQ_{z}P_{3-z}O₁₂ with 0≤x≤0.8; 0≤y≤1; 0≤z≤0.6 with M=Al or Y or a mixture of the two compounds and Q=Si and/or Se; or Li₁₊ₓZr₂₋ₓBₓ(PO₄)₃ with 0≤x≤0.25; or Li₁₊ₓZr₂₋ₓCaₓ(PO₄)₃ with 0≤x≤0.25; or Li₁₊ₓM₃ₓM₂₋ₓP₃O₁₂ with 0≤x≤1 and M³=Cr, V, Ca, B, Mg, Bi and/or Mo, M=Sc, Sn, Zr, Hf, Se or Si, or a mixture of these compounds,
   have a high conductivity.

A colloidal suspension of nanoparticles of electrolyte at a mass concentration comprised between 0.1% and 50%, preferably between 5% and 25%, and even more preferably at 10% is used to carry out the functionalization of the electrolyte particles. At a high concentration, there can be a risk of bridging and a lack of accessibility of the surface to be functionalized (risk of precipitation of particles that are not or are poorly functionalized). Preferably, the nanoparticles of electrolyte are dispersed in a liquid phase such as water or ethanol.

This reaction can be carried out in all suitable solvents that make it possible to solubilize the molecule Q-Z.

According to the molecule Q-Z the functionalization conditions can be optimized, in particular by adjusting the temperature and the duration of the reaction, and the solvent used. After having added a solution of Q-Z to a colloidal suspension of nanoparticles of electrolyte, the reaction medium is left under stirring for 0 h to 24 hours (preferably for 5 minutes to 12 hours, and more preferably for 0.5 hours to 2 hours), in such a way that at least one portion, preferably all of the molecules Q-Z can be grafted on the surface of the electrolyte nanoparticles. Functionalization can be carried out under heating, preferably at a temperature comprised between 20° C. and 100° C. The temperature of the reaction medium must be adapted to the choice of the functionalizing molecule Q-Z.

These functionalized nanoparticles therefore have a core made of an electrolyte material and a shell made of PEO. The thickness of the shell can be typically comprised between 1 nm and 100 nm; this thickness can be determined by transmission electron microscopy, typically after marking of the polymer by ruthenium oxide (RuO₄).

Advantageously, the nanoparticles thus functionalized are then purified by successive cycles of centrifugation and redispersions and/or by tangential filtration. In an embodiment, the colloidal suspension of functionalized electrolyte nanoparticles is centrifuged in such a way as to separate the functionalized particles from the molecules Q-Z that did not react present in the supernatant. After centrifugation, the supernatant is eliminated. The base comprising the functionalized particles is redispersed in the solvent.

Advantageously, the base comprising the functionalized particles is redispersed in a quantity of solvent that makes it possible to reach the desired dry extract. This redispersion can be carried out by any means, in particular by the use of an ultrasound bath or under magnetic and/or manual stirring.

Several centrifugation cycles and successive redispersions can be carried out in such a way as to eliminate the molecules Q-Z that did not react. Preferably at least one, more preferably at least two successive centrifugation and redispersion cycles are carried out.

After redispersion of the nanoparticles of functionalized electrolyte, the suspension can be reconcentrated until the desired dry extract is reached, by any suitable means.

Advantageously, the dry extract of a suspension of electrolyte nanoparticles functionalized by PEO comprises more than 40% (by volume) of solid electrolyte material, preferably more than 60% and more preferably more than 70% solid electrolyte material.

2. Development of an Electrolyte Layer from Nanoparticles of Electrolyte or Electronic Insulator Functionalized by PEO According to the Invention

According to the invention, the solid electrolyte can be deposited electrophoretically, by the coating method, dip-coating, or by other deposition techniques known to those skilled in the art allowing for the use of a suspension of nanoparticles of electrolyte or electronic insulator functionalized by PEO.

Advantageously, the dry extract of the suspension of nanoparticles of electrolyte or electronic insulator functionalized by PEO used to deposit an electrolyte layer electrophoretically, by dip-coating or by other deposition techniques known to those skilled in the art according to the invention is less than 30% by weight; such a suspension is sufficiently stable during deposition. Preferably, the solid electrolyte is deposited electrophoretically, or by dip-coating. These two techniques advantageously make it possible to easily carry out compact defect-free layers.

Nature of the Current Collector Substrate

The electrolyte layer is deposited on an anode 12 layer and/or a cathode 22 layer, themselves formed on a conductive substrate 11, 21 using an appropriate process, and/or directly on a sufficiently conductive substrate 11, 21.

This conductive or sufficiently conductive substrate 11, 21 is used as a current collector within batteries that use an electrolyte according to the invention. This substrate can be metallic, for example a metal foil, or a polymeric or metalized non-metallic foil (i.e. coated with a layer of metal). The substrate is preferably chosen from foils made from titanium, copper, nickel or stainless steel.

The metal foil can be coated with a layer of noble metal, in particular chosen from gold, platinum, titanium or alloys containing mostly at least one or more of these metals, or with a layer of conductive material of the ITO type (which has the advantage of also acting as a diffusion barrier).

In batteries that use porous electrodes, the liquid phase carrying lithium ions that impregnates the porous electrode is in direct contact with the current collector. However, when this liquid phase carrying lithium ions is in contact with the metal substrate and polarized at highly anodic potentials for the cathode and highly cathodic potentials for the anode, these liquid phases carrying lithium ions are able to induce a dissolution of the current collector. These parasite reactions can degrade the service life of the battery and accelerate the self-discharging thereof. In order to prevent this, aluminum current collectors are used at the cathode, in all lithium-ion batteries. Aluminum has this particularity of anodizing at highly anodic potentials, and the oxide layer thus formed on the surface thereof protects it from dissolution. However, aluminum has a melting temperature close to 600° C. and cannot be used for the manufacture of batteries that comprise at least one porous electrode. The consolidation treatments of all-solid-state electrodes would lead to melting the current collector. Thus, to prevent the parasite reactions that can degrade the service life of the battery and accelerate the self-discharging thereof, a foil made of titanium is advantageously used as a current collector at the cathode. During the operation of the battery, the foil made of titanium will, like aluminum, anodize and its oxide layer will prevent any parasite reactions of dissolution of the titanium in contact with the liquid phase carrying lithium ions. In addition, as titanium has a melting point that is much higher than aluminum, all-solid-state electrodes according to the invention, can be made directly on this type of foil.

Using these massive materials, in particular foils made of titanium, copper or nickel, also makes it possible to protect the cut edges of the electrodes of batteries from corrosion phenomena.

Stainless steel can also be used as a current collector, in particular when it contains titanium or aluminum as alloy element, or when it has on the surface a thin layer of protective oxide.

Other substrates used as a current collector can be used such as less noble metal foils covered with a protective coating, making it possible to prevent any dissolution of these foils induced by the presence of electrolytes in contact with them.

These less noble metal foils can be foils made of Copper, Nickel or foils of metal alloys such as foils made of stainless steel, foils of Fe—Ni alloy, Be—Ni—Cr alloy, Ni—Cr alloy or Ni—Ti alloy.

The coating that can be used to protect the substrates used as current collectors can be of different natures. It can be a:
i. thin layer obtained by sol-gel process of the same material as that of the electrode. The absence of porosity in this film makes it possible to prevent contact between a liquid phase carrying lithium ions and the metal current collector.
ii. thin layer obtained by vacuum deposition, in particular by physical vapor deposition (PVD) or by chemical vapor deposition (CVD), of the same material as that of the electrode,
iii. thin metal layer, dense, without defects, such as a thin metal layer of gold, titanium, platinum, palladium, tungsten or molybdenum. These metals can be used to protect the current collectors because they have good conduction properties and can resist heat treatments during the subsequent method of manufacturing electrodes. This layer can in particular be made by electrochemistry, PVD, CVD, evaporation, ALD.
iv. thin layer of carbon such as diamond carbon, graphic, deposited by ALD, PVD, CVD or by inking of a sol-gel solution making it possible to obtain after heat treatment a carbon-doped inorganic phase to make it conductive,
v. layer of conducting oxides, such as a layer of ITO (indium tin oxide) only deposited on the cathode substrate because the oxides are reduced to low potentials,
vi. layer of conducting nitrides, such as a layer of TiN only deposited on the cathode substrate because the nitrides insert the lithium at low potentials.

The coating that can be used to protect the substrates used as current collectors must be electronically conductive in order not to harm the operation of the electrode deposited later on this coating, by making it too resistive.

Generally, in order to not excessively impact the operation of the battery cells, the maximum dissolution currents measured on the substrates, at the operating potentials of the electrodes, expressed in μA/cm², must be 1000 times less than the surface capacities of the electrodes expressed in μAh/cm².

The deposition of anode and cathode layers can be carried out on this type of substrate used as a current collector by any suitable means. These anode and cathode layers can be dense, i.e. have a volume porosity less than 20%. They can also be porous, and in this case it is preferred that they have an interconnected network of open porosity; this porosity is preferably a mesoporosity, with pores of an average diameter comprised between 2 nm and 50 nm.

Deposition Electrophoretically of Nanoparticles of Electrolyte or Electronic Insulator are Functionalized by PEO

The method according to the invention can use the electrophoresis of suspensions of nanoparticles as a deposition technique of porous layers. The method of deposition of layers from a suspension of nanoparticles is known as such (see for example EP 2 774 208 B1). The electrophoretic deposition of particles functionalized by PEO is made by application of an electric field between the conductive substrate on which the deposit is made and a counter electrode, in order to move the charged particles in the colloidal suspension and to deposit them on the substrate. In order to ensure the stability of the colloidal suspension, polar nanoparticles, and/or advantageously having a Zeta potential with an absolute value greater than 25 mV, are preferably used.

The electrophoretic deposition rate depends on the applied electric field and the electrophoretic mobility of particles in suspension. It can be very high. For example, for an applied voltage of 200 V, the deposition rate can be as high as about 10 μm/min.

The inventor has observed that this technique makes it possible to deposit very homogenous layers on very large areas (subject to the concentration in particles and the electric field being homogeneous over the surface of the substrate). Deposition by electrophoresis may be applied in a “batch” (static) type process or in a continuous process.

The electrolyte layer is deposited on an anode 12 layer and/or a cathode 22 layer, themselves formed on a conductive substrate 11, 21 using an appropriate process, and/or directly on a sufficiently conductive substrate. The substrate used as a current collector within batteries that use porous electrodes according to the invention is preferably chosen from foils of titanium, copper, stainless steel or nickel.

For example, a metal substrate, such as a stainless steel foil, of a thickness that can be for example 5 μm, or a polymer strip having an electrically conducting surface layer, can be used for the conductive substrate. It is possible for example to use a stainless steel foil with a thickness of 5 μm. The metal foil can be coated with a layer of noble metal, in particular chosen from gold, platinum, titanium or alloys containing mostly at least one or more of these metals, or with a layer of conductive material of the ITO type (which has the advantage of also acting as a diffusion barrier). Anode and cathode layers can be deposited on this type of conductive substrate any suitable means. These anode and cathode layers can be dense, i.e. have a volume porosity less than 20%. They can also be porous, and in this case it is preferred that they have an interconnected network of open porosity; this porosity is preferably a mesoporosity, with pores of an average diameter comprised between 2 nm and 50 nm. During the electrophoretic deposition, a stabilized power supply can be used to apply a voltage between the conductive substrate and two electrodes located on each side of this substrate. This voltage may be direct or alternating. Precise monitoring of the currents obtained helps to monitor the deposited thicknesses and to control them precisely.

Electrophoretic deposition of an electrolyte layer gives perfect coverage of the electrode layer surface regardless of its geometry, even in the presence of roughness defects. Consequently, it can guarantee dielectric properties of the layer.

Deposition by electrophoresis makes it possible to prevent the use of additional organic binders, because compact layers are obtained directly. The compactness of the layer obtained by electrophoretic deposition, and the lack of any large quantities of organic compounds in the layer can limit or even prevent risks of crazing or the appearance of other defects in the layer during drying steps. A step of mechanical compaction can be done, for example by pressing, before drying, to improve the quality of the layer; this does not replace mechanical consolidation after drying, that has a different effect.

Deposition of Nanoparticles of Electrolyte or of Electronic Insulator Functionalized by PEO

Electrolyte nanoparticles or electronic insulator functionalized by PEO can be deposited in particular by the coating method, dip-coating, or by other deposition techniques known to those skilled in the art, and this, regardless of the chemical nature of the nanoparticles used. This deposition method is preferred when the nanoparticles of electrolyte or electronic insulator functionalized by PEO are little or not at all electronically charged. In order to obtain a layer of desired thickness, the step of deposition by dip-coating of nanoparticles of electrolyte or electronic insulator functionalized by PEO followed by the step of drying of the layer obtained are repeated as often as necessary.

Although this succession of coating steps by dipping/drying is time consuming, the method of deposition by dip-coating is a method that is simple, safe, and easy to implement and to industrialize, and it makes it possible to obtain a homogenous and compact final layer.

According to the invention, the nanoparticles of electrolyte or electronic insulator functionalized by PEO can be deposited electrophoretically, by dip-coating, by ink-jet, by roll coating, by curtain coating, or by doctor blade.

These methods are simple and safe, and are easy to implement and industrialize. Electrophoretic deposition is a technique that makes it possible to uniformly deposit over large surfaces with high deposition speeds. Coating techniques, in particular by dipping, roll, curtain or doctor blade, make it possible to simplify the management of the baths with respect to the techniques of electrophoretic deposition. Ink-jet deposition makes it possible to make localized depositions.

Depositions of nanoparticles of electrolyte or electronic insulator functionalized by PEO are advantageously carried out by electrophoresis or by dip-coating. The suspensions of nanoparticles used to carry out depositions by dip-coating are more concentrated than those used to carry out depositions by electrophoresis.

Drying and Densification of the Layer of Nanoparticles of Electrolyte or Electronic Insulator Functionalized by PEO

After deposition, whether electrophoretically or by dip-coating, the solid layer of nanoparticles obtained must be dried. The drying must not induce the formation of cracks. For this reason it is preferred to carry it out in controlled humidity and temperature conditions.

Advantageously, these layers have crystallized nanoparticles of electrolyte or electronic insulator linked together by amorphous PEO. Advantageously, these layers have a content in nanoparticles of electrolyte or electronic insulator greater than 35%, preferably greater than 50%, preferably greater than 60% and even more preferably greater than 70% by volume.

The use of nanoparticles of electronic insulator limits the self-discharging of the battery and contributes to the amorphization of the PEO.

Advantageously, the nanoparticles of electrolyte or electronic insulator present in these layers of a size D₅₀ less than 100 nm, preferably less than 50 nm and more preferably less than or equal to 30 nm; this value relates to the “core” of the “core-shell” nanoparticles. This particle size provides good conductivity of the lithium ions between the particles of electrolyte and the PEO.

The electrolyte layer obtained after drying has a thickness less than 10 μm, preferably less than 6 μm, preferably less than 5 μm, preferably about 3 μm so as to limit the thickness and the weight of the battery without reducing its properties.

After drying, the layer of nanoparticles can be densified; this step is optional.

Densification makes it possible to reduce the porosity of the layer. The structure of the layer obtained after densification is continuous, practically without porosity, and ions can easily migrate in it, without it being necessary to add liquid electrolytes containing lithium salts, such liquid electrolytes being the cause of low thermal resistance of batteries, poor resistance in aging of batteries. The layers with a base of solid electrolyte and PEO obtained after drying and densification generally have a porosity less than 20%, preferably less than 15% by volume, more preferably less than 10% by volume, and optimally less than 5% by volume. This value can be determined by transmission electron microscopy on a cross-section.

The densification of the layer after the deposition thereof can be carried out by any suitable means, preferably:

a) by any mechanical means, in particular by mechanical compression, preferably uniaxial compression;

b) by thermocompression, i.e. by heat treatment under pressure. The optimum temperature depends closely on the chemical composition of the deposited materials, it also depends on particle sizes and the compactness of the layer. It is preferable to maintain a controlled atmosphere to prevent oxidation and surface pollution of the deposited particles. Advantageously, compaction is carried out in a controlled atmosphere and at temperatures comprised between ambient temperature and the melting temperature of the PEO used; thermocompression can be carried out at a temperature comprised between ambient temperature (about 20° C.) and about 300° C.; but it is preferred to not exceed 200° C. (or more preferably 100° C.) in order to prevent the degradation of the PEO.

Densification of the nanoparticles of electrolyte or electronic insulator functionalized by PEO can be obtained only by mechanical compression (application of a mechanical pressure) because the shell of these nanoparticles comprises PEO, a polymer that is easily deformed at a relatively low pressure. Advantageously compression is carried out in a range of pressures comprised between 10 MPa and 500 MPa, preferably between 50 MPa and 200 MPa and at a temperature of about 20° C. to 200° C.

At the interfaces the PEO is amorphous and provides good ionic contact between the solid electrolyte particles. The PEO can thus conduct the lithium ions, and this, even in the absence of liquid electrolyte. It favors the assembly of the lithium-ion battery at low temperature, thus limiting the risk of interdiffusion at the interfaces between the electrolytes and the electrodes.

The electrolyte layer obtained after densification has a thickness less than 10 μm, preferably less than 6 μm, preferably less than 5 μm, preferably about 3 μm so as to limit the thickness and the weight of the battery without reducing its properties.

The method of densification that has just been described can be carried out during the assembly of the battery, which will be described hereinbelow.

3. Assembly of a Battery Comprising an Electrolyte Layer from Nanoparticles of Electrolyte or Electronic Insulator Functionalized by PEO According to the Invention

One of the purposes of the invention is to supply new electrolytes, preferably in a thin layer, for secondary lithium-ion batteries. Here, a battery with an electrolyte according to the invention is described.

A suspension of nanoparticles of a precursor material of an electrolyte layer according to the invention can be prepared by precipitation or solvothermally, in particular hydrothermally, which directly leads to nanoparticles with good crystallinity. The electrolyte layer is deposited electrophoretically or by dip coating on a cathode layer 22 covering a substrate 21 and/or on an anode layer 12 covering a substrate 11; in both cases said substrate has to have conductivity that is sufficient to be able to act as a cathodic or anodic current collector, respectively.

The assembly of the cell formed by an anode layer 12, the electrolyte layer according to the invention 13, 23 and a cathode layer 22 is done by hot pressing, preferably in an inert atmosphere. The temperature is advantageously comprised between 20° C. and 300° C., preferably between 20° C. and 200° C., more preferably between 20° C. and 100° C. The pressure is advantageously uniaxial and comprised between 10 MPa and 200 MPa, and preferably between 50 MPa and 200 MPa.

A cell that is entirely solid and rigid is thus obtained.

We describe here another example of manufacturing a lithium-ion battery according to the invention. This method comprises the steps of:
(1) Providing at least two conductive substrate covered beforehand with a layer of material that can be used as an anode and, respectively, as a cathode (these layers being called “anode layer” 12 and “cathode layer” 22),
(2) Providing of a colloidal suspension of core-shell nanoparticles comprising particles of a material that can be used as an electrolyte, on which a shell made from PEO is grafted,
(3) Deposition of a layer of said core-shell nanoparticles by electrophoresis or by dip-coating, from said colloidal suspension over at least one cathode or anode layer obtained in step (1),
(4) Drying the electrolyte layer thus obtained, preferably in an airflow,
(5) Stacking of the cathode and anode layers of which at least one is coated with the electrolyte layer 13, 23,
(6) Treating the stack of anode and cathode layers obtained in step (5) by mechanical compression and/or heat treatment so as to assemble the electrolyte layers present on the anode and cathode layers.

The order of steps (1) and (2) is not important.

Advantageously, the anode and cathode layers can be dense electrodes, i.e. electrodes that have a volume porosity less than 20%, porous electrodes, preferably having an interconnected network of open pores or mesoporous electrodes, preferably having an interconnected network of open mesopores.

Due to the very large specific surface area of the porous, preferably mesoporous electrodes, during the use thereof with a liquid electrolyte parasite reactions can occur between the electrodes and the electrolyte; these reactions are at least partially irreversible. In an advantageous embodiment a very thin layer of an electronically insulating material, that is preferably an ionic conductor and that covers and is preferably without defects, is applied on the porous, preferably mesoporous, electrode layer, so as to passivate the surface of the electrode, limit the kinetics of the parasite electrochemical reactions and even block these parasite reactions. Advantageously, this dielectric layer can be a layer of an electrically-insulating material deposited on and inside the pores of the porous electrode layers, preferably by the technique of atomic layer deposition ALD or chemically in solution CSD, in particular after drying the porous electrode layer or after consolidation of the porous electrode layer.

In the framework of dense electrodes and in another advantageous embodiment a very thin layer of an electronically insulating material, which is preferably ion conducting, can be applied on the electrode layer so as to reduce the interfacial resistance that exists between the dense electrode and the electrolyte.

This layer of electronically insulating material, which is preferably ion conducting, advantageously has an electronic conductivity less than 10⁻⁸ S/cm. Advantageously this deposition is carried out at least on one face of the electrode, whether it is porous or dense, that forms the interface between the electrode and the electrolyte. This layer can for example by made of alumina Al₂O₃, silica SiO₂, or zirconia ZrO₂. Li₄Ti₅O₁₂ can be used on the cathode or another material that, like Li₄Ti₅O₁₂, has the characteristic of not inserting, at the operating voltages of the cathode, lithium and of behaving as an electronic insulator.

Alternatively this layer of an electronically insulating material can be an ionic conductor, which advantageously has an electronic conductivity less than 10 S/cm. This material has to be chosen in such a way as to not insert lithium, at the operating voltages of the battery, but only to transport it. For this can be used for example Li₃PO₄, Li₃BO₃, lithium lanthanum zirconium oxide (called LLZO), such as Li₇La₃Zr₂O₁₂, that have a wide range of operating potential. On the other hand, lithium lanthanum titanium oxide (abbreviated LLTO), such as Li₃ₓLa_{2/3-x}TiO₃, lithium aluminum titanium phosphate (abbreviated LATP), lithium aluminum germanium phosphate (abbreviated LAGP), can be used only in contact with cathodes because their range of operating potential is limited; beyond this range they are able to insert the lithium into their crystallographic structure.

This deposition further improves the performance of lithium-ion batteries including at least one electrode, whether it is porous or dense. In the case of impregnated porous electrodes, this deposition makes it possible to reduce the interface faradic reactions with the electrolytes. These parasite reactions are all the more so important when the temperature is high; they are at the origin of reversible and/or irreversible losses in capacity. In the case of dense electrodes in contact with the solid electrolyte, it also makes it possible to limit the interface resistance linked to the appearance of space charges.

Very advantageously this deposition is carried out by a technique allowing for a covering coating (also called conformal deposition), i.e. a deposition that faithfully reproduces the atomic topography of the substrate on which it is applied. The ALD (Atomic Layer Deposition) or CSD (Chemical Solution Deposition) technique, known as such, can be suitable. It can be implemented on dense electrodes before the deposition of the electrolyte layer and before the assembly of the cell. It can be implemented on the porous, preferably mesoporous, electrodes after manufacture, before and/or after the deposition of the electrolyte layer and before and/or after the assembly of the cell. The deposition technique by ALD is done layer by layer, by a cyclic method, and makes it possible to carry out an encapsulating coating that truly reproduces the topography of the substrate; it lines the entire surface of the electrodes. This covering coating typically has a thickness comprised between 1 nm and 5 nm. The deposition technique by CSD makes it possible to carry out an encapsulating coating that truly reproduces the topography of the substrate; it lines the entire surface of the electrodes. This covering coating typically has a thickness less than 5 nm, preferably comprised between 1 nm and 5 nm.

When the electrodes used are porous and covered with a nanolayer of an electronically insulating material, preferably ion conducting, it is preferable that the primary diameter D₅₀ of the particles of electrode material used to create them be at least 10 nm in order to prevent the layer of electronically insulating material, preferably ion conducting, from clogging the open porosity of the electrode layer.

The layer of an electronically insulating material, preferably ion conducting, must be deposited only on electrodes that do not contain any organic binder. Indeed, deposition by ALD is carried out at a temperature typically comprised between 100° C. and 300° C. At this temperature the organic materials that form the binder (for example the polymers contained in the electrodes made by tape casting of ink) risk decomposing and will pollute the ALD reactor. Moreover, the presence of residual polymers in contact with particles of active electrode material can prevent the ALD coating from covering the entire surface of the particles, which is detrimental to its effectiveness.

For example, a layer of alumina of a thickness of about 1.6 nm can be suitable.

If the electrode is a cathode it can be made from a cathode material P chosen from:
oxides LiMn₂O₄, Li₁₊ₓMn₂₋ₓO₄ with 0<x<0.15, LiCoO₂, LiNiO₂, LiMn_{1.5}Ni_{0.5}O₄, LiMn₁₅Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/z}O₂ with x+y+z=10;
phosphates LiFePO₄, LiMnPO₄, LiCoPO₄, LiNiPO₄, Li₃V₂(PO₄)₃; phosphates of formula LiMM′PO₄, with M and M′ (M≠M′) selected from Fe, Mn, Ni, Co, V;
all lithium forms of the following chalcogenides: V₂O₅, V₃O₈, TiS₂, titanium oxysulfides (TiO_{y}S_{z} with z=2−y and 0.3≤y≤1), tungsten oxysulfides (WO_{y}S_{z} with 0.6<y<3 and 0.1<z<2), CuS, CuS₂, preferably LiₓV₂O₅ with 0<x≤2, LiₓV₃O₈ with 0<x≤1.7, LiₓTiS₂ with 0<x≤1, titanium oxysulfides and lithium oxysulfides LiₓTiO_{y}S_{z} with z=2−y, LiₓWO_{y}S_{z}, LiₓCuS, LiₓCuS₂.

If the electrode is an anode it can be made from an anode material P chosen from:
carbon nanotubes, graphene, graphite;
lithium iron phosphate (of typical formula LiFePO₄);
silicon and tin oxinitrides (of typical formula SiₐSn_{b}O_{y}N_{z} with a>0, b>0, a+b≤2, 0<y≤4, 0<z≤3) (also called SiTON), and in particular SiSn_{0.87}O_{1.2}N_{1.72}; as well as the oxynitride-carbides of typical formula SiₐSn_{b}C_{c}O_{y}N_{z} with a>0, b>0, a+b≤2, 0<c<10, 0<y<24, 0<z<17;
nitrides of the type SiₓN_{y} (in particular with x=3 and y=4), SnₓN_{y} (in particular with x=3 and y=4), ZnₓN_{y} (in particular with x=3 and y=2), Li₃₋ₓMₓN (with 0≤x≤0.5 for M=Co, 0≤x≤0.6 for M=Ni, 0≤x≤0.3 for M=Cu); Si₃₋ₓMₓN₄ with M=Co or Fe and 0≤x≤3.
oxides SnO₂, SnO, Li₂SnO₃, SnSiO₃, LiₓSiO_{y} (x>=0 and 2>y>0), Li₄Ti₅O₁₂, TiNb₂O₇, Co₃O₄, SnB_{0.6}P_{0.4}O_{2.9} and TiO₂,
composite oxides TiNb₂O₇ comprising between 0% and 10% carbon by weight, preferably carbon being chosen from graphene and the carbon nanotubes.

On dense, porous, preferably mesoporous electrodes, coated or not with an electronically insulating material, preferably ion conducting by ALD or by CSD, an electrolyte according to the invention can be carried out.

In order to obtain a battery with high energy density and with high power density, this battery advantageously contains a porous, preferably mesoporous, anode layer 12 and cathode layer 22, and an electrolyte according to the invention.

Advantageously, the anode and cathode layers, coated or not with a layer by ALD or by CSD of an electronically insulating material, preferably ion conducting, then covered with an electrolyte layer according to the invention are hot pressed in order to favor the assembly of the cell.

Once the assembly is carried out, a rigid, multilayer system formed from one or more assembled cells is obtained. In an advantageous embodiment, a very thin layer can be applied, that covers and is preferably without defects, by ALD or by CSD of an electronically insulating material, preferably ion conducting as indicated hereinabove, on this rigid, multilayer system of one or more assembled cells. This makes it possible to cover in a single treatment all the surfaces of the porous electrodes when the latter are used. In addition to passivating the surface of the electrodes, this treatment makes it possible to cover only the accessible surfaces of the mesoporous structure, i.e. the surfaces that will layer be in contact with the phases carrying lithium ions.

This deposition improves the performance of lithium-ion batteries including at least one porous electrode. The improvement observed consists substantially in a reduction of the faradic reactions at the interface between the phases carrying lithium ions and the electrode.

Very advantageously this deposition is carried out by a technique allowing for a covering coating (also called conformal deposition), i.e. a deposition that faithfully reproduces the atomic topography of the substrate on which it is applied. The ALD (Atomic Layer Deposition) or CSD (Chemical Solution Deposition) techniques, known as such, can be suitable. These deposition techniques by ALD and by CSD make it possible to carry out a coating that lines the entire surface of the electrodes. This covering coating typically has a thickness less than 5 nm, preferably comprised between 1 nm and 5 nm.

In order to avoid the use of any liquid that could induce malfunctions, in particular risks of fire of the battery, the carrying out of a battery comprising dense electrodes and an electrolyte according to the invention will be preferred.

Advantageously, a battery comprising at least one porous, preferably mesoporous, electrode and an electrolyte according to the invention has increased performance, in particular a high power density. An example of manufacturing a lithium-ion battery according to the invention comprising at least one porous, preferably mesoporous electrode, is described hereinbelow. This method comprises the steps of:
(1) Providing of a colloidal suspension comprising nanoparticles of at least one cathode material with an average primary diameter D₅₀ less than or equal to 50 nm, with these nanoparticles preferably being aggregated or agglomerated so as to obtain a porous layer of at least one cathode material;
(2) Providing of a colloidal suspension comprising nanoparticles of at least one anode material with an average primary diameter D₅₀ less than or equal to 50 nm, with these nanoparticles preferably being aggregated or agglomerated so as to obtain a porous layer of at least one anode material;
(3) Providing of at least two flat conductive substrates, preferably metal, said conductive substrates can be used as current collectors of the battery,
(4) Deposition of at least one thin layer of cathode, respectively anode, by dip-coating, by ink-jet, by roll coating, by curtain coating, by doctor blade or by electrophoresis, preferably by pulsed-current galvanostatic electrodeposition, from said suspension of nanoparticles of material obtained in step (1), respectively in step (2), on said substrate obtained in step (3),
(5) Drying the layer thus obtained in the step (4),
(6) Optionally, deposition by ALD or by CSD of a layer of electronically-insulating material on and inside pores of the cathode layer, and/or of anode in step (5),
(7) Deposition by electrophoresis or by dip-coating of an electrolyte layer from a suspension of core-shell particles according to the invention, on the cathode layer, and/or anode layer obtained in step 5) or in step 6), to obtain and first and/or a second intermediate structure,
(8) Drying of the layer thus obtained in step (7), preferably in an air flow,
(9) Creating a stack from said first and/or second intermediate structure to obtain a stack of the “substrate/anode/electrolyte/cathode/substrate” type:
   either by depositing an anode layer 12 on said first intermediate structure,
   either by depositing a cathode layer 22 on said second intermediate structure,
   or by superposing said first intermediate structure and said second intermediate structure in such a way that the two electrolyte layers are placed one on the other,
(10) Hot pressing of the anode and cathode layers obtained in step (9) in such a way as to assemble the films obtained in step (8) present on the anode and cathode layers,
(11) Optionally, deposition by ALD or by CSD of a layer of electronically-insulating material on and inside pores of the layer of the thermocompressed stack obtained in step (10),
(12) Impregnating of the structure obtained in step (10) or after step (11) by a phase carrying lithium ions leading to the obtaining of an impregnated structure, preferably a cell.

The order of steps (1), (2) and (3) is not important.

Once the assembly of a stack forming a battery by hot pressing is completed, it can be impregnated with a phase carrying lithium ions, then encapsulated in an encapsulation system as presented hereinafter, then cut according to cutting planes that make it possible to obtain unit battery components, exposing on each one of the cutting planes anode and cathode connections 50 of the battery as indicated hereinafter on which a termination system is then deposited, as indicated hereinafter.

In another embodiment, once the assembly of a stack forming a battery by hot pressing is completed, it can be encapsulated in an encapsulation system as presented hereinafter, then cut according to cutting planes that make it possible to obtain unit battery components, exposing on each one of the cutting planes anode and cathode connections 50 of the battery as indicated hereinafter, then impregnated with a phase carrying lithium ions before the deposition of the termination system, as indicated hereinafter.

This phase can be a solution formed by a lithium salt dissolved in an organic solvent or a mixture of organic solvents, and/or dissolved in a polymer containing at least one lithium salt, and/or dissolved in an ionic liquid (i.e. a melted lithium salt) containing at least one lithium salt. This phase can also be a solution formed from a mixture of these components.

The phase carrying lithium ions makes it possible to impregnate the porous electrodes when such electrodes are used. The electrolyte layer according to the invention is not impregnated by the phase carrying lithium ions.

The phase carrying lithium ions, can be an ionic liquid containing lithium salts, possibly diluted with an organic solvent or a mixture of organic solvents containing a lithium salt that can be different from the one dissolved in the ionic liquid.

The ionic liquid is formed from a cation associated with an anion; this anion and this cation are chosen in such a way that the ionic liquid is in the liquid state in the operating temperature range of the accumulator. The ionic liquid has the advantage of having a high thermal stability, a reduced flammability, of being non-volatile, of being little toxic and a good wettability of ceramics, which are materials that can be used as electrode materials. Surprisingly, the percentage by weight of ionic liquid contained in the phase carrying lithium ions can be greater than 50%, preferably greater than 60% and even more preferably greater than 70%, and this contrary to the lithium-ion batteries of the prior art where the percentage by weight of ionic liquid in the electrolyte must be less than 50% by weight in order for the battery to retain a capacity and a voltage that are high in discharge as well as good stability in cycling. Beyond 50% by weight the capacity of the battery of the prior art degrades, as indicated in application US 2010/209 783 Al. This can be explained by the presence of polymer binders within the electrolyte of the battery of the prior art; these binders are slightly wetted by the ionic liquid inducing a poor ion conduction within the phase carrying lithium ions thus causing a degradation in the capacity of the battery.

The batteries using a porous electrode are, preferably, binder-free. Because of this, these batteries can use a phase carrying lithium ions comprising more than 50% by weight of at least one ionic liquid without degrading the final capacity of the battery.

The phase carrying lithium ions can comprise a mixture of several ionic liquids.

Advantageously, the ionic liquid can be a cation of the type 1-Ethyl-3-methylimidazolium (also called EMI+) and/or n-propyl-n-methylpyrrolidinium (also called PYR₁₃⁺) and/or n-butyl-n-methylpyrrolidinium (also called PYR₁₄⁺), associated with anions of the type bis (trifluoromethanesulfonyl)imide (TFSI⁻) and/or bis(fluorosulfonyl)imide (FSI⁻). To form an electrolyte, a lithium salt such as LiTFSI can be dissolved in the ionic liquid which is used as a solvent or in a solvent such as γ-butyrolactone. γ-butyrolactone prevents the crystallization of the ionic liquids inducing an operating range in temperature of the latter that is greater, in particular at low temperature.

The phase carrying lithium ions can be an electrolytic solution comprising PYR14TFSI and LiTFSI; these abbreviations will be defined hereinbelow.

Advantageously, when the porous anode or cathode comprises a lithium phosphate, the phase carrying lithium ions comprises a solid electrolyte such as LiBH₄ or a mixture of LiBH₄ with one or more compounds chosen from LiCl, LiI and LiBr. LiBH₄ is a good conductor of lithium and has a low melting point that facilitates the impregnation thereof in the porous electrodes, in particular by dipping. Due to its extremely reducing properties, LiBH₄ is little used as an electrolyte. Using a protective film on the surface of porous lithium phosphate electrodes prevents the reduction in electrode materials, in particular cathode materials, by LiBH₄ and prevents degradation of the electrodes.

Advantageously, the phase carrying lithium ions comprises a least one ionic liquid, preferably at least one ionic liquid at ambient temperature, such as PYR14TFSI, possibly diluted in at least one solvent, such as γ-butyrolactone.

Advantageously, the phase carrying lithium ions comprises between 10% and 40% by weight of a solvent, preferably between 30 and 40% by weight of a solvent, and even more preferably between 30 and 40% by weight of γ-butyrolactone.

Advantageously the phase carrying lithium ions comprises more than 50% by weight of at least one ionic liquid and less than 50% solvent, which limits the risks of safety and of ignition in case of malfunction of the batteries comprising such a phase carrying lithium ions.

Advantageously, the phase carrying lithium ions comprises:
between 30 and 40% by weight of a solvent, preferably between 30 and 40% by weight of γ-butyrolactone, and
more than 50% by weight of at least one ionic liquid, preferably more than 50% by weight of PYR14TFSI.

The phase carrying lithium ions can be an electrolytic solution comprising PYR14TFSI, LiTFSI and γ-butyrolactone, preferably an electrolytic solution comprising about 90% by weight of PYR14TFSI, 0.7 M of LiTFSI and 10% by weight of γ-butyrolactone.

The porous, preferably mesoporous, electrodes are able to absorb a liquid phase by simple capillarity when the average diameter D₅₀ of the pores is between 2 nm and 80 nm, preferably between 2 nm and 50 nm, preferably between 6 nm and 30 nm, preferably between 8 nm and 20 nm. This entirely unexpected effect is particularly favored with the decrease in the diameter of the pores of these electrodes.

The pores of this assembly, preferably when it is made from ceramic materials, can easily be wetted by an ionic liquid, by mixtures of ionic liquids or by a solution comprising at least 50% by weight of at least one ionic liquid diluted with an organic solvent or diluted with a mixture of organic solvents. Advantageously, the porous, preferably mesoporous, electrodes are impregnated by an electrolyte, preferably a phase carrying lithium ions such as an ionic liquid containing lithium salts, possibly diluted with an organic solvent or a mixture of organic solvents containing a lithium salt that can be different from the one dissolved in the ionic liquid.

A lithium-ion battery cell with very high power density is thus obtained.

### 4. Encapsulation

The battery or the assembly, multilayer rigid system formed by one or more assembled cells, covered or not with a dielectric layer, possibly impregnated by a phase carrying lithium ions, must then be encapsulated by a suitable method in order to ensure the protection thereof from the atmosphere. The encapsulation system comprises at least one layer, and preferably represents a stack of several layers. If the encapsulation system is composed of a single layer, it must be deposited by ALD or be made of parylene and/or polyimide. These encapsulation layers have to be chemically stable, resist high temperatures and be impermeable to the atmosphere (barrier layers). One of the methods described in patent applications WO 2017/115 032, WO 2016/001584, WO2016/001588 or WO 2014/131997 can be used. Preferably, said at least one encapsulation layers covers four of the six faces of said battery, the two other faces of the battery being covered by the terminations.

Advantageously, the battery or the assembly, can be covered with an encapsulation system 30 formed by a stack of several layers, namely a sequence, preferably z sequences, comprising:
a first covering layer, preferably chosen from parylene, parylene of the F type, polyimide, epoxy resins, silicone, polyamide and/or a mixture of the latter, deposited on the stack of anode and cathode foils,
a second covering layer comprised of an electrically-insulating material, deposited by atomic layer deposition on said first covering layer.

This sequence can be repeated z times with z≥1. This multilayer sequence has a barrier effect. The more the sequence of the encapsulation system is repeated, the more substantial this barrier effect will be. It will be as substantial as the thin layers deposited are numerous.

Advantageously, the first covering layer is a polymer layer, for example made of silicone (deposited for example by impregnation or by plasma-assisted chemical vapor deposition from hexamethyldisiloxane (HMDSO)), or epoxy resin, or polyimide, polyamide, or poly-para-xylylene (more commonly known as parylene), preferably with a parylene and/or polyimide base. This first covering layer makes it possible to protect the sensitive elements of the battery from its environment. The thickness of said first covering layer is, preferably, comprised between 0.5 μm and 3 μm.

Advantageously, the first covering layer can be parylene of the C type, parylene of the D type, parylene of the N type (CAS 1633-22-3), parylene of the F type or a mixture of parylene of the C, D, N and/or F type. Parylene (also called polyparaxylylene or poly(p-xylylene)) is a dielectric, transparent, semi-crystalline material that has high thermodynamic stability, excellent resistance to solvents as well as very low permeability. Parylene also has barrier properties that make it possible to protect the battery from its external environment. The protection of the battery is increased when this first covering layer is made from parylene of the F type. It can be vacuum deposited, by a chemical vapor deposition technique (CVD). This first encapsulation layer is advantageously obtained from the condensation of gaseous monomers deposited by chemical vapor deposition (CVD) on the surfaces, which makes it possible to have a conformal, thin and uniform covering, of all of the accessible surfaces of the object. It makes it possible to follow the variations in volume of the battery during the operation thereof and facilitates the specific cutting of batteries through its elastic properties. The thickness of this first encapsulation layer is comprised between 2 μm and 10 μm, preferably comprised between 2 μm and 5 μm and even more preferably about 3 μm. It makes it possible to cover all of the accessible surfaces of the stack, to close only on the surface the access to the pores of these accessible surfaces and to render uniform the chemical nature of the substrate. The first covering layer does not enter into the pores of the battery or of the assembly, as the size of the deposited polymers is too large for them to enter the pores of the stack.

This first covering layer is advantageously rigid; it cannot be considered as a flexible surface. The encapsulation can thus be carried out directly on the stacks, the coating able to penetrate into all the available cavities.

In an embodiment a first layer of parylene is deposited, such as a layer of parylene C, parylene D, a layer of parylene N (CAS No.: 1633-22-3) or a layer comprising a mixture of parylene C, D, and/or N. Parylene (also called polyparaxylylene or poly(p-xylylene)) is a dielectric, transparent, semi-crystalline material that has high thermodynamic stability, excellent resistance to solvents as well as very low permeability.

This layer of parylene makes it possible to protect the sensitive elements of the battery from their environment. This protection is increased when this first encapsulation layer is made from parylene N.

In another embodiment, a first layer with a polyimide base is deposited. This layer of polyimide protects the sensitive elements of the battery from their environment.

In another advantageous embodiment, the first encapsulation layer is comprised of a first layer of polyimide, preferably about 1 μm thick on which is deposited a second layer of parylene, preferably about 2 μm thick. This protection is increased when this second layer of parylene, preferable about 2 μm thick is made from parylene N. The layer of polyimide combined with the layer of parylene improves the protection of the sensitive elements of the battery from their environment.

However, the inventors have observed that this first layer, when it has a parylene base, does not have sufficient stability in the presence of oxygen. When this first layer has a polyimide base, it is not sufficiently sealed, in particular in the presence of water. For these reasons a second layer is deposited which coats the first layer.

Advantageously, a second covering layer comprised of an electrically-insulating material can be deposited by a conformal deposition technique, such as atomic layer deposition (ALD) on the first layer. Thus a conformal covering is obtained on all of the accessible surfaces of the stack covered beforehand with the first covering layer, preferably a first layer of parylene and/or polyimide; this second layer is preferably an inorganic layer. The growth of the layer deposited by ALD is influenced by the nature of the substrate. A layer deposited by ALD on a substrate that has different zones of different chemical natures will have non-homogenous growth, that can generate a loss of integrity of this second protective layer. This second layer deposited on the first layer of parylene and/or of polyimide protects the first layer of parylene and/or of polyimide from the air and improves the duration of the service life of the encapsulated battery.

The deposition techniques by ALD are particularly well suited for covering surfaces that have a high roughness entirely tight and conformal. They make it possible to realize conformal layers, free from defects, such as holes (layers referred to as “pinhole-free”) and represent very good barriers. Their WVTR coefficient is extremely low. The WVTR coefficient (water vapor transmission rate) makes it possible to evaluate the permeance to steam of the encapsulation system. The lower the WVTR coefficient is, the tighter the encapsulation system is. For example, a layer of Al₂O₃ of 100 nm thick deposited by ALD has a permeation to steam of 0.00034 g/m²·d. The second covering layer can be made of a ceramic material, vitreous material or vitroceramic material, for example in form of oxide, of the Al₂O₃ type, of nitride, phosphates, oxynitride, or siloxane. This second encapsulation layer has a thickness less than 200 nm, preferably comprised between 5 nm and 200 nm, more preferably comprised between 10 nm and 100 nm, between 10 nm and 50 nm, and even more preferably of about fifty nanometers.

This second covering layer deposited by ALD makes it possible on the one hand, to ensure the tightness of the structure, i.e. to prevent the migration of water inside the structure and on the other hand to protect the first covering layer, preferably of parylene and/or polyimide, preferably parylene of the F type, from the atmosphere so as to prevent the degradation thereof.

However, these layers deposited by ALD are very fragile mechanically and require a rigid support surface to ensure their protective role. The deposition of a fragile layer on a flexible surface would lead to the formation of cracks, generating a loss of integrity of this protective layer.

In an embodiment, a third covering layer is deposited on the second covering layer or on an encapsulation system 30 formed by a stack of several layers as described hereinabove, namely a sequence, preferably z sequences of the encapsulation system with z≥1, to increase the protection of the battery cells from their external environment. Typically, this third layer is made of polymer, for example silicone (deposited for example by impregnation or plasma-assisted chemical vapor deposition from hexamethyldisiloxane (HMDSO, CAS No.: 107-46-0)), or epoxy resin, or polyimide, or parylene.

Furthermore, the encapsulation system 30 can comprise an alternating succession of layers of parylene and/or polyimide, preferably about 3 μm thick, and of layers comprised of an electrically-insulating material such as in organic layers conformally deposited by ALD as described hereinabove to create a multilayer encapsulation system. In order to improve the performance of the encapsulation, the encapsulation system can comprise a first layer of parylene and/or polyimide, preferably about 3 μm thick, a second layer comprised of an electrically-insulating material, preferably an inorganic layer, conformally deposited by ALD on the first layer, a third layer of parylene and/or polyimide, preferably about 3 μm thick deposited on the second layer and a fourth layer comprised of an electrically-insulating material conformally deposited by ALD on the third layer.

The battery or the assembly encapsulated in this sequence of the encapsulation system 30, preferably in z sequences, can then be covered with a last covering layer so as to mechanically protect the stack thus encapsulated and optionally provide it with an aesthetic aspect. This last covering layer protects and improves the service life of the battery. Advantageously this last covering layer is also chosen to resist a high temperature, and has a mechanical resistance that is sufficient to protect the battery during the later use thereof. Advantageously, the thickness of this last covering layer is comprised between 1 μm and 50 μm. Ideally, the thickness of this last covering layer is about 10-15 μm, such a range of thickness makes it possible to protect the battery from mechanical damage.

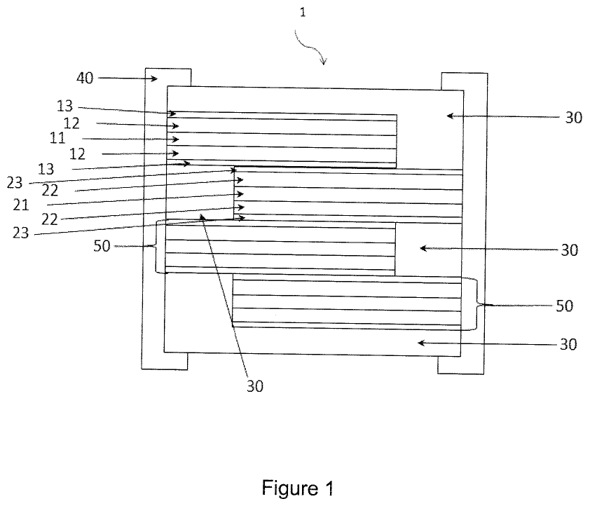

Advantageously, this last covering layer is deposited on an encapsulation system 30 formed by a stack of several layers as described hereinabove, namely a sequence, preferably z sequences of the encapsulation system with z 1, preferably on this alternating succession of layers of parylene and/or polyimide, preferably about 3 μm thick and of inorganic layers conformally deposited by ALD, in order to increase the protection of the battery cells from their external environment and protect them from mechanical damage. This last encapsulation layer has, preferably, a thickness of about 10-15 μm. This last covering layer is preferably with a base of epoxy resin, polyethylene naphthalate (PEN), polyimide, polyamide, polyurethane, silicone, sol-gel silica or organic silica. Advantageously, this last covering layer is deposited by dipping. Typically, this last layer is made of polymer, for example silicone (deposited for example by dipping or plasma-assisted chemical vapor deposition from hexamethyldisiloxane (HMDSO)), or epoxy resin, or parylene, or polyimide. For example, a layer of silicone (typical thickness of about 15 μm) can be deposited by injection in order to protect the battery from mechanical damage. The encapsulation system 30 shown in FIG. 1, advantageously comprises a stack of several layers, namely of a sequence, preferably z sequences with z 1, comprising:
a first covering layer, preferably chosen from parylene, parylene of the F type, polyimide, epoxy resins, silicone, polyamide and/or a mixture of the latter, deposited on the stack of anode and cathode foils,
a second covering layer comprised of an electrically-insulating material, deposited by atomic layer deposition on said first covering layer,
as well as a last covering layer deposited on this stack of several layers, preferably with a base of epoxy resin, polyethylene naphthalate (PEN), polyimide, polyamide, polyurethane, silicone, sol-gel silica or organic silica.

These materials resist high temperatures and the battery can thus be assembled easily by welding on electronic boards without the appearance of a vitreous transition. Advantageously, the encapsulation of the battery is carried out on four of the six faces of the stack. The encapsulation layers surround the periphery of the stack, with the rest of the protection from the atmosphere being provided by the layers obtained by the terminations.

After the step of encapsulation, the stack thus encapsulated is then cut according to cut planes making it possible to obtain unit battery components, exposing on each one of the cutting planes anode and cathode connections 50 of the battery, in such a way that the encapsulation system 30 covers four of the six faces of said battery, preferably continuously, so that the system can be assembled without welding, with the other two faces of the battery being covered later by the terminations 40.

In an advantageous embodiment, the stack thus encapsulated and cut when it comprises porous electrodes, can be impregnated, in an anhydrous atmosphere, by a phase carrying lithium ions such as an ionic liquid containing lithium salts, possibly diluted in an organic solvent or a mixture of organic solvents containing a lithium salt that can be different from the one dissolved in the ionic liquid, as indicated in the present application. The impregnation can be carried out by dipping in an electrolytic solution such as an ionic liquid containing lithium salts, possibly diluted in an organic solvent or a mixture of organic solvents containing a lithium salt that can be different from the one dissolved in the ionic liquid. The ionic liquid enters instantly by capillarity in the porosities.

After the step of encapsulation, cutting and possibly impregnation of the battery, terminations 40 are added to establish the electrical contacts required for the proper operation of the battery.

### 5. Terminations

Advantageously, the battery comprises terminations 40 at where the cathode, respectively anode, current collectors are apparent. Preferably, the anode connections and the cathode connections are on the opposite side of the stack. On and around these connections 50 is deposited a termination system 40. The connections can be metalized using plasma deposition techniques known to those skilled in the art, preferably by ALD and/or by immersion in a conductive epoxy resin (charged with silver) and/or a molten bath of tin. Preferably, the terminations are formed from a stack of layers successively comprising a first thin electronically-conductive covering layer, preferably metal, deposited by ALD, a second epoxy resin layer charged with silver deposited on the first layer and a third layer with a tin base deposited on the second layer. The first conductive layer deposited by ALD is used to protect the section of the battery from humidity. This first conductive layer deposited by ALD is optional. It makes it possible to increase the calendar service life of the battery by reducing the WVTR at the termination. This first thin covering layer can in particular be metal or with a metal nitride base. The second layer made of epoxy resin charged with silver makes it possible to provide the “flexibility” for the connections without breaking the electrical contact when the electric circuit is subjected to thermal and/or vibratory stresses.

The third metallization layer with a tin base is used to ensure the weldability of the battery. In another embodiment, this third layer can be comprised of two layers of different materials. A first layer coming into contact with the epoxy resin layer charged with silver. This layer is made of nickel and is carried out by electrolytic deposition. The layer of nickel is used as a heat barrier and protects the rest of the component from the diffusion during the assembly steps by remelting. The last layer, deposited on the nickel layer is also a metallization layer, preferably made of tin in order to render the interface compatible with assemblies via remelting. This layer of tin can be deposited either by dipping in a molten tin bath or by electrodeposition; these techniques are known as such.

For certain assemblies on copper tracks by micro-wiring, it may be necessary to have a last metallization layer made of copper. Such a layer can be realized by electrodeposition in place of tin.

In another embodiment, the terminations 40 can be formed from a stack of layers successively comprising a layer made of epoxy resin charged with silver and a second layer with a tin or nickel base deposited on the first layer.

In another embodiment, the terminations 40 can be formed from a stack of layer that successively comprise a layer of epoxy resin charged with silver, a second layer with a nickel base deposited on the first layer and a third layer with a tin or copper base.

In a preferred embodiment, the terminations 40 can be formed from different layers which are respectively, in a non-limited manner, a conducting polymer layer such as an epoxy resin charged with silver, a nickel layer and a tin layer.

In another preferred embodiment, the terminations 40 are formed, at the edges of the cathode and anode connections, from a first stack of layers that successively comprise a first layer made from a material charged with graphite, preferably epoxy resin charged with graphite, and a second layer comprising metal copper obtained from an ink charged with nanoparticles of copper deposited on the first layer. This first stack of terminations is then sintered by infrared flash lamp in such a way as to obtain a covering of the cathode and anode connections by a layer of metal copper.

According to the final use of the battery, the terminations can comprise, additionally, a second stack of layers disposed on the first stack of the terminations successively comprising a first layer of a tin-zinc alloy deposited, preferably by dipping in a molten tin-zinc bath, so as to ensure the tightness of the batter at least cost and a second layer with a pure tin base deposited by electrodeposition or a second layer comprising an alloy with a silver, palladium and copper base deposited on this first layer of the second stack.

The terminations 40 make it possible to take the alternating positive and negative electrical connections on each one of the ends of the battery. These terminations make it possible to create the electrical connections in parallel between the different elements of the battery. For this, only the cathode connections exit on one end, and the anode connections are available on another end.

Advantageously, the anode and cathode connections are on the opposite sides of the stack.

All the embodiments relating to the assembly of the battery, the impregnating of the assembled battery when at least one porous electrode is used, deposition of the encapsulation system and of the terminations described hereinabove can be combined together independently of one another, if this combination is realistic for those skilled in the art.

### EXAMPLES

The example hereinbelow show certain aspects of the invention but do not limit the scope of it.

### Example 1: Manufacture of an Electrolyte Layer of Lithium Phosphate/PEO

1. Preparation of a Suspension of Solid Electrolyte Nanoparticles Covered with Ion-Conducting Polymer

a. Realization of a Suspension of Nanoparticles of Li₃PO₄

Two solutions were prepared:

11.44 g of CH₃COOLi, 2H₂O were dissolved in 112 ml of water, then 56 ml of ethanol were added under intense stirring to the medium in order to obtain a solution A.

4.0584 g of H₃PO₄ were diluted in 105.6 ml of water, then 45.6 ml of ethanol were added to this solution in order to obtain a second solution called hereinafter solution B.

Solution B was then added, under intense stirring, to solution A.

The solution obtained, perfectly limpid after the disappearance of bubbles formed during the mixing, was added to 1.2 liters of acetone under the action of a homogenizer of the Ultraturrax™ type in order to homogenize the medium. A white precipitation in suspension in the liquid phase was immediately observed.

The reaction medium was homogenized for 5 minutes then was maintained 10 minutes under magnetic stirring. It was left to decant for 1 to 2 hours. The supernatant was discarded then the remaining suspension was centrifuged 10 minutes at 6000 rpm. Then 300 ml of water was added to put the precipitate back into suspension (use of a sonotrode, magnetic stirring). The colloidal suspension thus obtained comprises nanoparticles of Li₃PO₄ at a concentration of 10 g/L.

b. Realization of a Colloidal Suspension of Nanoparticles of Li₃PO₄ Functionalized by PEO

The previously obtained nanoparticles of electrolyte in suspension at a concentration of 10 g/L were then functionalized by methoxy-PEO5000-phosphonate (CAS: 911391-95-2 with n=114).

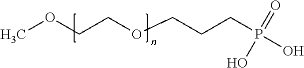

An aqueous solution of this molecule was added to a colloidal suspension of electrolyte nanoparticles.

After adding this solution to the colloidal suspension of electrolyte nanoparticles, the reaction medium was left under stirring for 1 hour at 70° C. so that the phosphonate groups graft to the surface of the electrolyte nanoparticles of Li₃PO₄.

The nanoparticles thus functionalized were then purified by successive cycles of centrifugation and redispersion so as to separate the functionalized particles from the molecules that did not react present in the supernatant. After centrifugation, the supernatant was eliminated. The base comprising the functionalized particles was redispersed in a quantity of solvent that makes it possible to reach the desired dry extract.

2. Fabrication of an Anode Layer

A suspension of the anode material was prepared by grinding/dispersion a Li₄Ti₅O₁₂ powder in absolute ethanol at about 10 g/L with a few ppm of citric acid. The grinding was carried out in such a way as to obtain a stable suspension with a particle size D₅₀ less than 70 nm.

An anode layer 12 was deposited by electrophoresis of the nanoparticles of Li₄Ti₅O₁₂ contained in the suspension; this layer was deposited on the two faces of a first conductive substrate with a thickness of 1 μm; it was dried and thermally treated at about 600° C. This anode layer 12 was a so-called “dense” layer, having undergone a step of thermal consolidation that leads to the increase in the density of the layer.

The anode was then coated with a protective coating of Li₃PO₄ of a thickness of 10 nm deposited by ALD.

3. Fabrication of a Cathode Layer

A suspension was prepared at about 10 g/L of cathode material by grinding/dispersion of a LiMn₂O₄ powder in water. The grinding of the suspension was carried out in such a way as to obtain a stable suspension with a particle size D₅₀ less than 50 nm.

A cathode was prepared by electrophoretic deposition of nanoparticles of LiMn₂O₄ contained in the suspension described hereinabove, in the form of a thin film deposited on the two faces of a second conductive substrate; this cathode layer of thickness 1 μm was then thermally treated at about 600° C. This cathode layer was a so-called “dense” layer, having undergone a step of thermal consolidation that leads to the increase in the density of the layer.

The cathode was then coated with a protective coating of Li₃PO₄ of a thickness of 10 nm deposited by ALD.

4. Manufacture of an Electrolyte Layer of Lithium Phosphate/PEO

The nanoparticles thus functionalized in suspension at 10 g/L in ethanol were deposited by electrophoresis on the first (respectively second) conductive substrate covered beforehand with an anode layer 12 as indicated hereinabove in point 2 of the example hereinabove, respectively cathode layer as indicated hereinabove in point 3 of the example hereinabove, by applying between the substrate and a counter electrode, both immersed in the colloidal suspension, a voltage of 45 V until a layer 1.4 μm thick is obtained.

The layer thus obtained was dried.

5. Manufacture of a Battery Comprising an Electrolyte According to the Invention

The anode obtained in example 1.2 and the cathode obtained in example 1.3 were stacked on their electrolyte faces and the whole was maintained under pressure at 50 MPa for 15 minutes at 200° C.; a lithium-ion battery was thus obtained that was able to be charged and discharged in many cycles.

1. Method for manufacturing a solid electrolyte (13, 23), preferably as a thin layer, for lithium-ion battery or supercapacitor, deposited on an electrode (12, 22), comprising the steps of:
a. providing a conductive substrate (11, 21), covered beforehand with a layer of material that can be used as an electrode (“electrode layer”),
b. deposition on said electrode layer of an electrolyte layer (13, 23), preferably by electrophoresis or by dip-coating, from a suspension of core-shell particles comprising, as a core, a particle of a material that can be used as an electrolyte and/or electronic insulator, on which a shell comprising PEO is grafted;
c. Drying the electrolyte layer (13, 23) thus obtained, preferably in an airflow;
d. optionally, densifying said electrolyte layer by mechanical compression and/or heat treatment.

2. Method according to claim 1, wherein the average size D₅₀ of primary core particles is less than 100 nm, preferably less than 50 nm and even more preferably less than or equal to 30 nm.

3. Method according to claim 1 or 2, wherein said core particles are obtained by hydrothermal or solvothermal synthesis.

4. Method according to any of claims 1 to 3, wherein the thickness of the shell of the core-shell particles is comprised between 1 nm and 100 nm.

5. Method according to any of claims 1 to 4, wherein the electrolyte layer obtained in step c) or d) has a thickness less than 10 μm, preferably less than about 6 μm.

6. Method according to any of claims 1 to 5, wherein the PEO has a weight average molar weight less than 7,000 g/mol, preferably about 5,000 g/mol.

7. Method according to any of claims 1 to 6, wherein the dry extract of the suspension of core-shell particles used in step b) is less than 30% by weight.

8. Use of a process according to any one of claims 1 to 7 for the manufacture of solid electrolytes, preferably in a thin layer, in electronic, electrical or electrotechnical devices and preferably in devices selected in the group composed of batteries, capacitors, supercapacitors, capacities, resistors, inductors, transistors.

9. Electrolyte, preferably in a thin layer, that can be obtained by the method according to any of claims 1 to 7.

10. Electrolyte, preferably in a thin layer, according to claim 9, comprising a solid electrolyte and PEO characterized in that it has a volume ratio of solid electrolyte/PEO greater than 35%, preferably greater than 50%, preferably greater than 60%, and even more preferably greater than 70%.

11. Electrolyte, preferably in a thin layer, according to claim 9 or 10, characterized in that it has a porosity less than 20%, preferably less than 15%, more preferably less than 10%.

12. Electrochemical device comprising at least one solid electrolyte solid, preferably in a thin layer, according to any of claim 9 or 10 or 11, preferably a lithium-ion battery or a supercapacitor.

13. Process for manufacturing a lithium-ion battery (1) implementing the method according to any of claims 1 to 7, and comprising the steps of:
i. Providing at least two conductive substrates (11, 21) that be used as current collectors of the battery, covered beforehand with a layer of a material that can be used as an anode and respectively as a cathode (“anode layer” (12) respectively “cathode layer” (22), and being covered over at least one portion of at least one of their faces with a cathode layer, respectively anode layer,
ii. Providing of a colloidal suspension comprising core-shell nanoparticles comprising as a core, a particle of a material that can be used as an electrolyte and/or electronic insulator, on which a shell comprising PEO is grafted,
iii. Deposition of an electrolyte layer (13, 23), preferably by electrophoresis or by dip-coating, from a suspension comprising core-shell particles obtained in step ii), on a cathode layer, and/or anode layer obtained in step i), to obtain and first and/or a second intermediate structure,
iv. Drying of the layer thus obtained in step iii), preferably in an air flow,
v. Creating a stack from said first and/or second intermediate structure to obtain a stack of the “substrate/anode/electrolyte/cathode/substrate” type:
either by depositing an anode layer 12 on said first intermediate structure,
either by depositing a cathode layer 22 on said second intermediate structure,
or by superposing said first intermediate structure and said second intermediate structure in such a way that the two electrolyte layers are placed one on the other,
vi. Densification of the stack obtained in the preceding step by mechanical compression and/or heat treatment of the stack leading to the obtaining of a battery.

14. Method according to claim 13, wherein the cathode is a dense electrode
or a dense electrode coated by ALD or chemically in a solution CSD with an electronically-insulating layer, preferably an electronically insulating and ionic conducting layer,
or a porous electrode,
or a porous electrode coated by ALD or chemically in a solution CSD with an electronically-insulating layer, preferably an electronically insulating and ionic conducting layer,
or, preferably, a mesoporous electrode,
or a mesoporous electrode coated by ALD or chemically in a solution CSD with an electronically-insulating layer, preferably an electronically insulating and ionic conducting layer,
and/or wherein the anode is a dense electrode
or a dense electrode coated by ALD or chemically in a solution CSD with an electronically-insulating layer, preferably an electronically insulating and ionic conducting layer,
or a porous electrode
or a porous electrode coated by ALD or chemically in a solution CSD with an electronically-insulating layer, preferably an electronically insulating and ionic conducting layer,
or, preferably, a mesoporous electrode,
or a mesoporous electrode coated by ALD or chemically in a solution CSD with an electronically-insulating layer, preferably an electronically insulating and ionic conducting layer.

15. Method according to any of claims 13 to 14, wherein after step vi):
is deposited successively, alternating, on the battery:
at least one first layer of parylene and/or polymide on said battery,
at least one second layer composed of an electrically-insulating material by ALD (Atomic Layer Deposition) on said first layer of parylene and or polyimide,
and on the alternating succession of at least one first and of at least one second layer is deposited a layer making it possible to protect the battery from mechanical damage of the battery, preferably made of silicone, epoxy resin, or parylene, thus forming, an encapsulation system of the battery,
the battery thus encapsulated is cut along two cutting planes to expose on each one of the cutting plans anode and cathode connections of the battery, in such a way that the encapsulation system covers four of the six faces of said battery, preferably continuously,
is deposited successively, on and around, these anode and cathode connections (50):
a first electrically-conductive layer, optional, preferably deposited by ALD,
a second layer with an epoxy resin base charged with silver, deposited on the first electronically-conductive layer, and
a third layer with a nickel base, deposited on the second layer, and
a fourth layer with a tin or copper base, deposited on the third layer.

16. Method according to any of claims 13 to 14, wherein after step vi):
is deposited successively, alternating, on the battery, an encapsulation system (30) formed by a succession of layers, namely a sequence, preferably z sequences, comprising:
a first covering layer, preferably chosen from parylene, parylene of the F type, polyimide, epoxy resins, silicone, polyamide and/or a mixture of the latter, deposited on the assembled stack,
a second covering layer comprised of an electrically-insulating material, deposited by atomic layer deposition on said first covering layer,
this sequence can be repeated z times with z≥1,
a last covering layer is deposited in this succession of layers of a material chosen from epoxy resin, polyethylene naphthalate (PEN), polyimide, polyamide, polyurethane, silicone, sol-gel silica or organic silica,
the battery thus encapsulated is cut along two cutting planes to expose on each one of the cutting plans anode and cathode connections of the battery, in such a way that the encapsulation system covers four of the six faces of said battery, preferably continuously,
is deposited successively, on and around, these anode and cathode connections (50):
a first layer of a material charged with graphite, preferably epoxy resin charged with graphite,
a second layer comprising metal copper obtained from an ink charged with nanoparticles of copper deposited on the first layer,
the layers obtained are thermally treated, preferably by infrared flash lamp in such a way as to obtain a covering of the cathode and anode connections by a layer of metal copper,
possibly, is deposited successively, on and around, this layer of metal copper:
a first layer of a tin-zinc alloy deposited, preferably by dipping in a molten tin-zinc bath, so as to ensure the tightness of the battery at least cost, and
a second layer with a pure tin base deposited by electrodeposition or a second layer comprising an alloy with a silver, palladium and copper base deposited on this first layer of a tin-zinc alloy.

17. Method according to claim 15, wherein the anode and cathode connections (50) are on the opposite sides of the stack.

18. Lithium-ion battery (1) able to be obtained by the method according to any of claims 13 to 16.
